(19) United States
(12) Patent Application Publication
(10) Pub. No.: US 2018/0253220 A1
(43) Pub. Date: Sep. 6, 2018

(54) USER INPUT MECHANISM

(71) Applicant: MOTIVII LIMITED, London, Greater London (GB)

(72) Inventor: Eamon TUHAMI, London (GB)

(21) Appl. No.: 15/561,347

(22) PCT Filed: Mar. 23, 2016
(86) PCT No.: PCT/GB2016/050819

§ 371 Date: Sep. 25, 2017

(30) Foreign Application Priority Data
Mar. 23, 2015 (GB) 1504877.0

(51) Int. Cl. G06F 3/0484; G06F 3/0488; G06F 3/0362

(52) U.S. Cl. CPC G06F 3/04847; G06F 3/04886; G04G 21/08; G06F 3/04842; G06F 3/0362

(57) ABSTRACT

The present invention relates to a computer-implemented method for receiving user input. The method comprises, at a device with a touch screen display: displaying an input range; displaying a virtually moveable indicator defining a value within the range; detecting a touch event at the touch screen display comprising user movement; and in response to the touch event: moving the indicator to modify the value within the range at a first constant speed when the speed of the user movement is above a threshold; and moving the indicator to modify the value within the range at a second lower constant speed when the speed of the user movement is below the threshold. Other variations on the method, a device and computer readable storage medium are also disclosed.

### FIELD OF INVENTION

The present invention is in the field of user interfaces. More particularly, but not exclusively, the present invention relates to a user input mechanism for a touch-screen device.

### BACKGROUND

User devices generally include input hardware to receive input from the user and display hardware to display information, such as the consequences of the input, back to the user.

At present, for user devices such as computers, smart-phones, and tablets, input hardware includes keyboards, mice, track-pads, touch-screens, and near-touch panels and screens.

User interfaces have been developed to manage user interaction with the input hardware and display hardware.

These user interfaces are often provided to application developers via user interface APIs for user interface libraries. The libraries may be dynamically linked libraries existing within the operating system architecture of the user device or libraries which are linked during compilation of the application software.

At present one problem with existing user interfaces is providing the ability to efficiently receive controlled granular input from the user. Such a problem is important in receiving an input value from a user within a range.

The dominant user input mechanism is a slider bar where a user drags and drops a control within a graphical user interface (GUI) along a defined range. The dropped location of the control within the range specifies the value.

Unfortunately, this user input mechanism does not provide the user with much fine-control over the positioning of the control and, therefore, more accurate receipt of the input desired to be provided by the user.

Therefore, an improved input mechanism is desired. This improved input mechanism may have several applications. For example, in one application it may be necessary to receive on a regular basis a measurement from a user with no technical expertise. In this example, it is desirable that the user input mechanism be both easy to use and responsive.

It is an object of the present invention to provide a user input mechanism which overcomes the disadvantages of the prior art, or at least provides a useful alternative.

### SUMMARY OF INVENTION

According to a first aspect of the invention there is provided a computer-implemented method for receiving user input, comprising:

at a device with a touch screen display:
displaying an input range;
displaying a virtually moveable indicator defining a value within the range;
detecting a touch event at the touch screen display comprising user movement; and
in response to the touch event:
moving the indicator to modify the value within the range at a first constant speed when the speed of the user movement is above a threshold; and
moving the indicator to modify the value within the range at a second constant speed when the speed of the user movement is below the threshold;
wherein the second constant speed is lower than the first constant speed.

The input range may be displayed as a gauge.

The indicator may define a motivation value and the user may move the indicator to define their motivation value.

The displayed input range may comprise a visual indicator for the entire range and a visual indicator for the range up to the currently defined value. The visual indicator for the range up to the currently defined value may change in colour, hue or brightness as the value changes in response to movement of the indicator. The virtually moveable indicator may be represented by the divide between the two visual indicators.

The input range may be displayed as a curved gauge. The gauge may be curved in a U-shape.

Previously displayed values may be represented on the input range.

The user movement may be within the input range.

The touch event may comprise selection of the indicator.

The method may further include the display of a numeric value corresponding to the value within the range.

According to a further aspect of the invention there is provided a computer readable storage medium having stored therein instructions, which when executed by a processor of a device with a touch screen display cause the device to perform the method of the above aspect.

According to a further aspect of the invention there is provided a device, including:

a touch screen display;
one or more processors; and
a computer readable storage medium according to the above aspect.

According to a further aspect of the invention there is provided a computer-implemented method for receiving user input, comprising:

at a device with a display and input:
displaying an input range;
displaying a virtually moveable indicator defining a value within the range; and
detecting an input event comprising user movement;
in response to the input event:
moving the indicator to modify the value within the range at a first constant speed when the speed of the user movement is above a threshold; and
moving the indicator to modify the value within the range at a second constant speed when the speed of the user movement is below the threshold;
wherein the second constant speed is lower than the first constant speed.

According to a further aspect of the invention there is provided a computer-implemented method for receiving user input, comprising:

at a device with a touch screen display:
displaying an input range;
displaying a virtually moveable indicator defining a value within the range;
detecting a touch event at the touch screen display comprising user movement; and
in response to the touch event, moving the indicator to modify the value within the range;
wherein the input range is displayed within a gauge curved in a U-shape.

According to a further aspect of the invention there is provided a computer readable storage medium having stored therein instructions, which when executed by a processor of a device with a display and input cause the device to perform the method of either of the above two aspects.

According to a further aspect of the invention there is provided a device, including:

A display;
An input;
One or more processors; and
A computer readable storage medium according to the above aspect.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a device in accordance with an embodiment of the invention;

FIG. 2: shows a block diagram illustrating an architecture of a device in accordance with an embodiment of the invention;

FIG. 3: shows a flow diagram illustrating a method in accordance with an embodiment of the invention;

FIG. 4: shows a diagram illustrating a user interface on a device in accordance with an embodiment of the invention;

FIGS. 5a to 5e:
shows diagrams illustrating a user interface in use on a device in accordance with an embodiment of the invention;

FIG. 6: shows a diagram illustrating a first speed of change in accordance with an embodiment of the invention;

FIG. 7: shows a diagram illustrating a threshold for first and second speeds of change in accordance with an embodiment of the invention;

FIGS. 8a to 8d:
show diagrams illustrating input maps for different iPhone versions;

FIGS. 9a to 9d:
show diagrams illustrating a user interface in accordance with an embodiment of the invention overlaid on an input maps for different versions of iPhones;

FIGS. 10a to 10d:
show diagrams illustrating a user interface in accordance with another embodiment of the invention overlaid on an input maps for different versions of iPhones; and

FIG. 11: shows a flow diagram illustrating a method in accordance with an embodiment of the invention.

### DETAILED DESCRIPTION OF PREFERRED EMBODIMENTS

The present invention provides a user input mechanism.

The inventor has encountered a need for receiving regular measurements from users with no technical expertise that relate to that user's motivation level. The inventor's requirements include detecting differences in motivation levels over time, therefore, a user input mechanism that provides the ability to receive both fine calibration of a value and large change in the value from a user was required. Existing user input mechanisms have proved unsuitable for this task.

The inventor discovered that, by detecting variations in speed in input values received from an input at a user device, a processor can manipulate the rate of change of the input to provide different levels of control to the user.

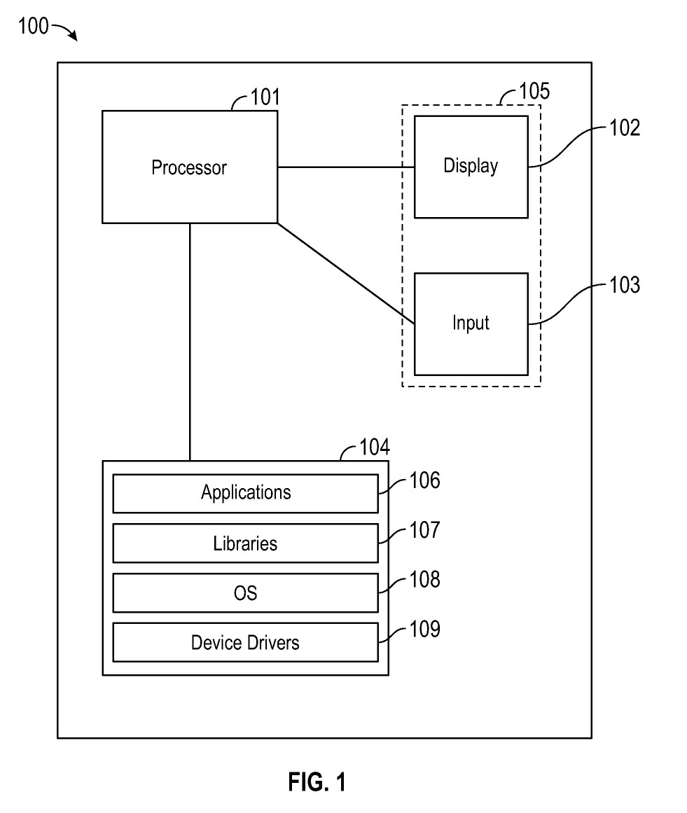

In FIG. 1, a device 100 in accordance with an embodiment of the invention is shown.

The device 100 includes a processor 101, a display 102, an input 103, and a memory 104.

The device 100 may be a portable computing apparatus such as a smart-phone, tablet or smart-watch, or a laptop, or desktop computer.

The display 102 and input 103 may be unified in a combined input/display apparatus 105 such as a touch-screen. Alternatively, the display 102 and input 103 may be separate, for example, where the input is a pointer device such as a mouse, a touch pad, or a device-specific input such as a crown on a smart-watch.

The memory 104 may be configured to store software applications 106, libraries 107, an operating system 108, and device drivers 109.

The processor 101 is configured to execute the software applications 106, libraries 107, operating system 108, and device drivers 109.

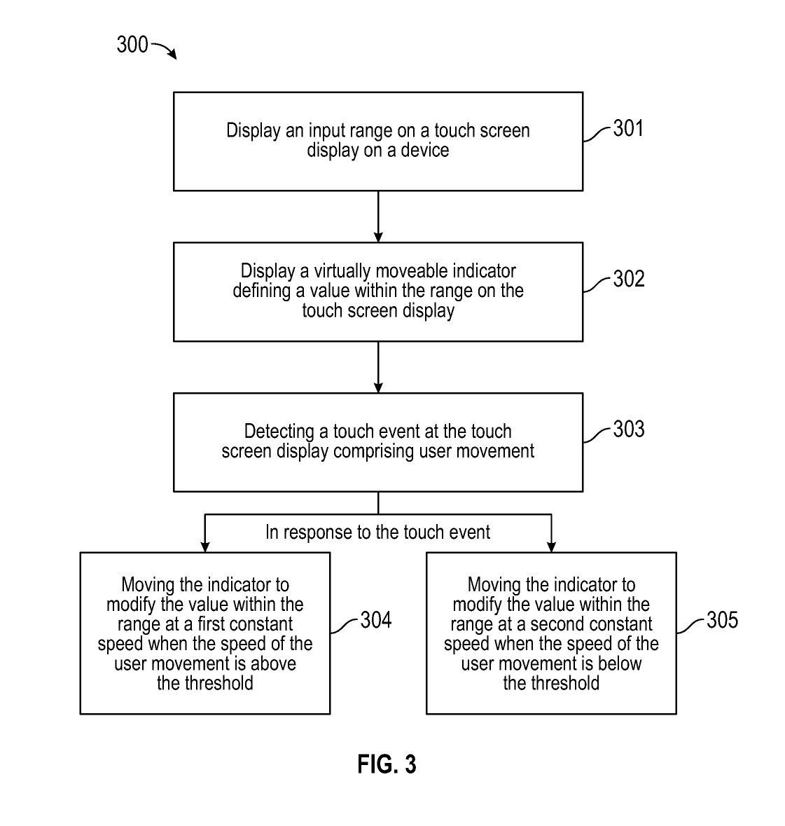

The device is configured to perform the method described in relation to FIG. 3.

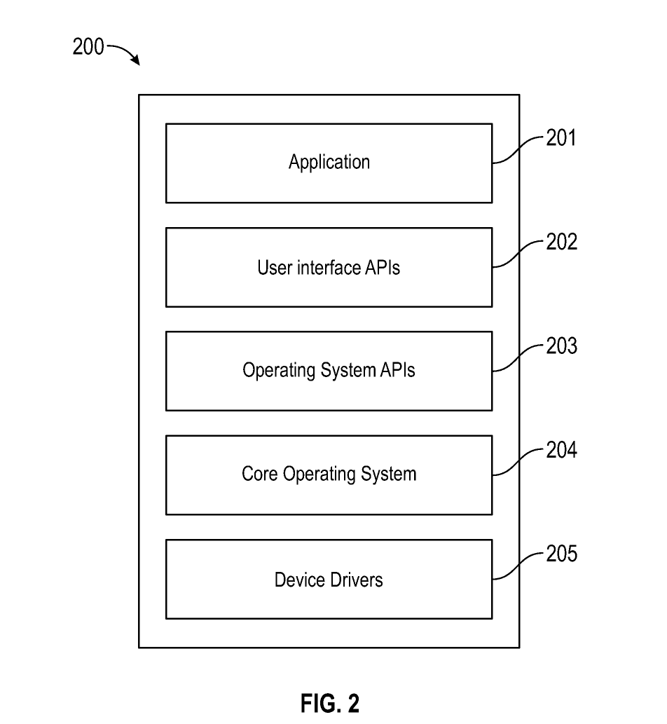

Referring to FIG. 2, the various layers of the architecture 200 of the device 100 will be described.

Application software 201 is provided at a top layer. Below this layer are user interface APIs 202 which provide access for the application software 201 to user interface libraries. Below this layer are operating system APIs 203 which provide access for the application software 201 and user interface libraries to the core operating system 204. Below the core operating system 204 are the device drivers 205 which provide access to the input and display hardware.

Referring to FIG. 3, a method 300 for providing a user input mechanism on the device in accordance with an embodiment of the invention will be described.

In step 301, an input range is displayed on the display of the device. The input range may be represented by a gauge interface element. In one embodiment, the gauge interface element is curved, for example, in a U-shape. The U-shaped curve of the interface element may be useful in permitting ease of input on a handheld device with a touch-screen input.

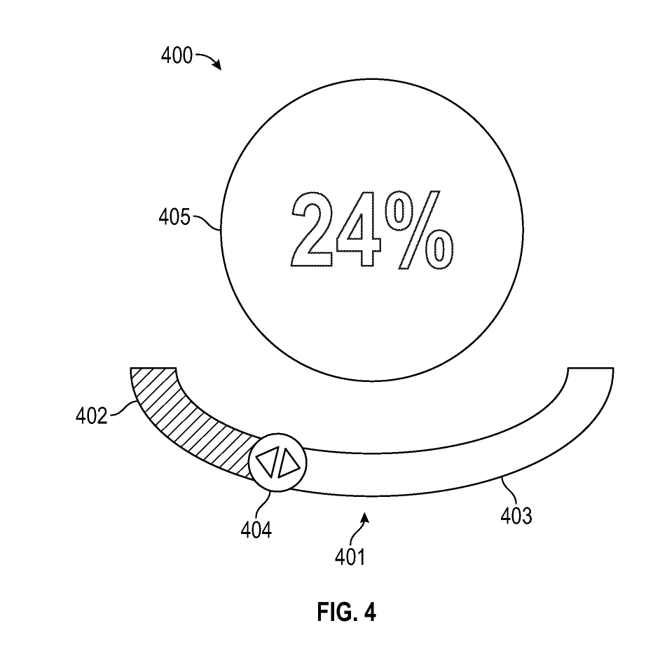

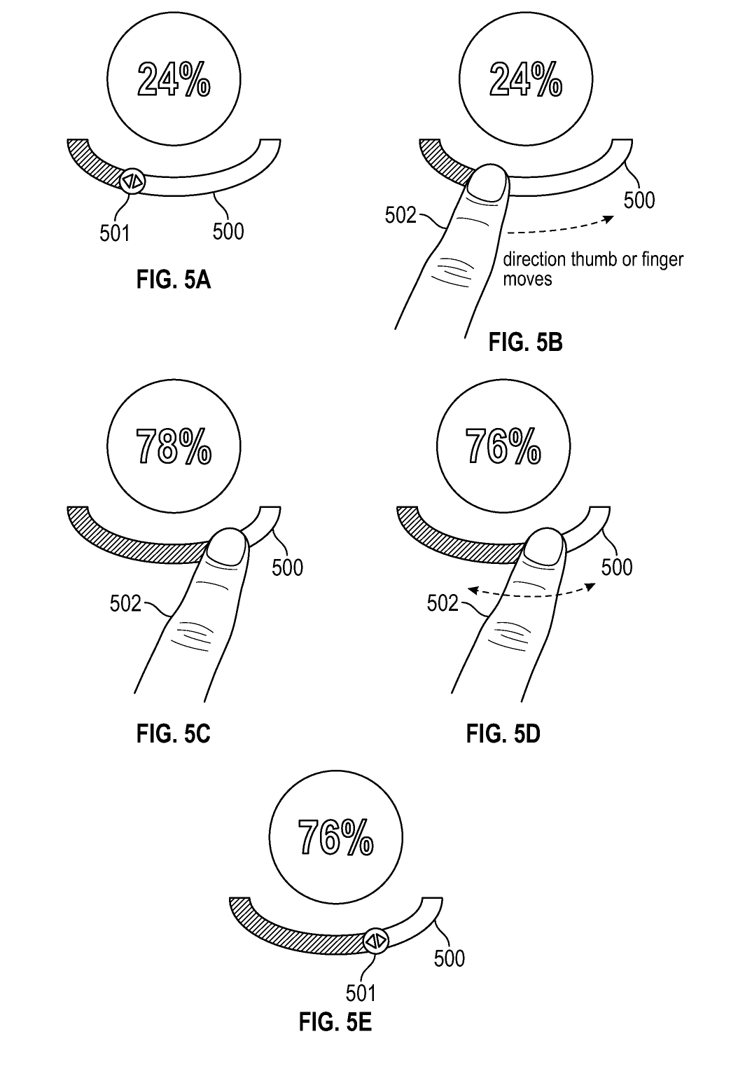

In step 302, a virtually moveable indicator defining a value within the range is displayed on the display of the device. The virtually moveable indicator may be a slider-type interface element as shown in FIG. 4. In an alternative embodiment, the virtually moveable indicator may be represented by the visual divide between two portions of the input range: the first portion being a fill bar representing the current value, and the second portion being a fill bar representing the remaining portion of the range. Each fill bar may be coloured differently. The colour of the fill bar for the first portion may change in colour, hue or brightness as the value changes during the input event.

In one embodiment, a numeric representation of the value is also displayed. The numeric value may assist the user in refining their input to provide greater accuracy.

In step 303, an input event is detected at the input of the device. The input event is preferably a touch event detected at a touch screen display-input. The input event may include a touch on or near to the virtually moveable indicator. The input event may include a swipe across the touch-screen. In an alternative embodiment, the input event includes movement of a crown input on a smart-watch device. The input event, therefore, corresponds to user movement, for example, user movement across the touch-screen or user movement of rotation of the crown.

In response to the input event, as shown in step 304, when the speed of the user movement is above a threshold, moving the indicator to modify the value within the range at a first constant speed and, as shown in step 305, when the speed of the user movement is below the threshold, moving the indicator to modify the value within the range at a second constant speed. The first constant speed is higher than the second such that the value is modified at a faster rate when user movement is over the threshold.

The threshold may be predefined. For example, the threshold may be predefined within the software or hardware implementing the method (i.e. by the developer of the device driver, operating system or library), or within the application software by the developer of the application software.

In one embodiment, the value represents a motivation value for a user and the user moves the indicator to define the motivation value for themselves.

The method described above may be provided within a library for use by application developers. The library may be dynamically linked at runtime or linked during compilation of software applications. In one embodiment, at least a part of the method described above is encapsulated within the device driver for the input and/or display hardware. In this embodiment, a developer may, for example, set a flag to activate the functionality of steps 304 and 305.

In FIG. 4, a display 400 for a device in accordance with an embodiment of the invention is shown.

An input range is shown on the display at 401. In this example, the input range 401 is shaped in a U-shaped curve. A first portion 402 of the input range 401 is coloured, for example, blue and a second portion 403 is differently coloured, for example, gray. The first portion 402 indicates the value currently defined and the second portion 403 indicates the remaining extent of the range.

In this example, the range is 0-100%.

A virtually moveable indicator is shown at 404. The value defined by the virtually moveable indicator is 24%.

A numeric representation of the value is also shown at 405.

In FIGS. 5a to 5e, an example of the invention in use will be described with reference to a touch screen for a device.

In FIG. 5a, an input bar 500 with a virtually moveable indicator 501 is displayed on the touch-screen of the device. The virtually moveable indicator 501 may represent a previously entered value. In this example, that value is 24%

In FIG. 5b, a user 502 is touching the touch-screen at the virtually moveable indicator 501 and moving across the touch-screen from left to right. The speed of movement is above a threshold.

FIG. 5c shows the effect of that movement and received input. The virtually moveable indicator 501 under the thumb of the user 502 has moved from left to right within the input range and increased the value to 78% at a rate of change at a first speed.

In FIG. 5d, the user's movement and received input is below the threshold, and the virtually moveable indicator 501 has moved left to decrease the value to 76%. The rate of change to decrease the value is at a lower second speed. This lower speed may permit finer control of the value.

In FIG. 5e, the user removes their touch from the touch-screen and the value received by the input mechanism is confirmed at 76%.

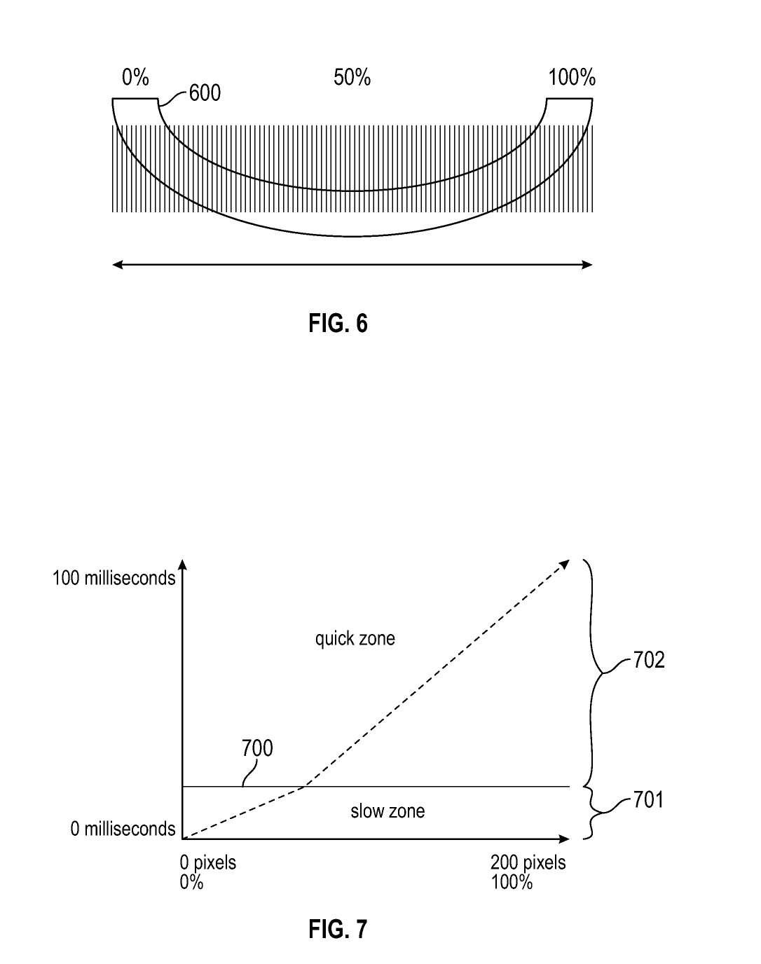

FIG. 6 shows an overlay of pixels of width 2 on an input range 600 of an embodiment of the invention.

In one example, where the input range 600 ranges from 0% to 100%, user movement above a threshold which equates to an input of 2 pixels increases or decreases the value by 1%.

In this example, when the user movement is below the threshold, user movement which equates to an input of 5 pixels is required to increase or decrease the value by 1%.

The threshold may, for example, be 10 pixels of movement detected by the input within 0.2 seconds.

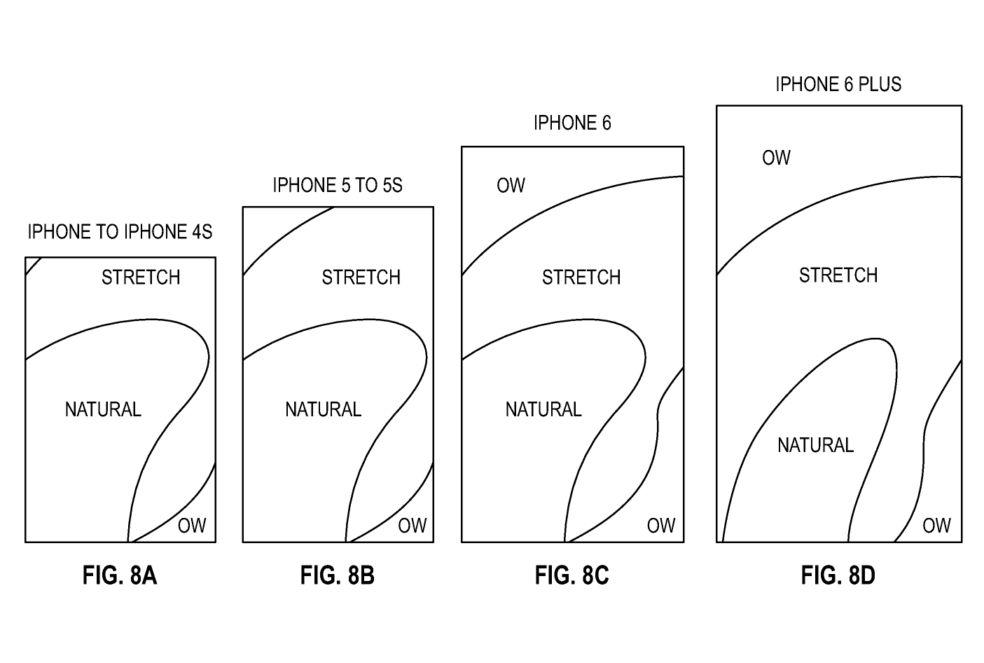

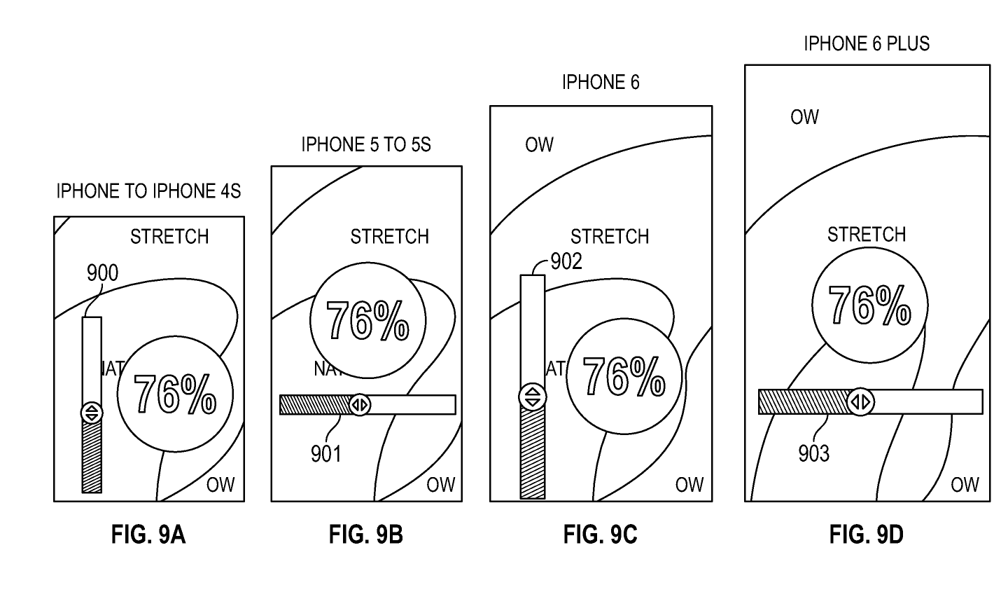

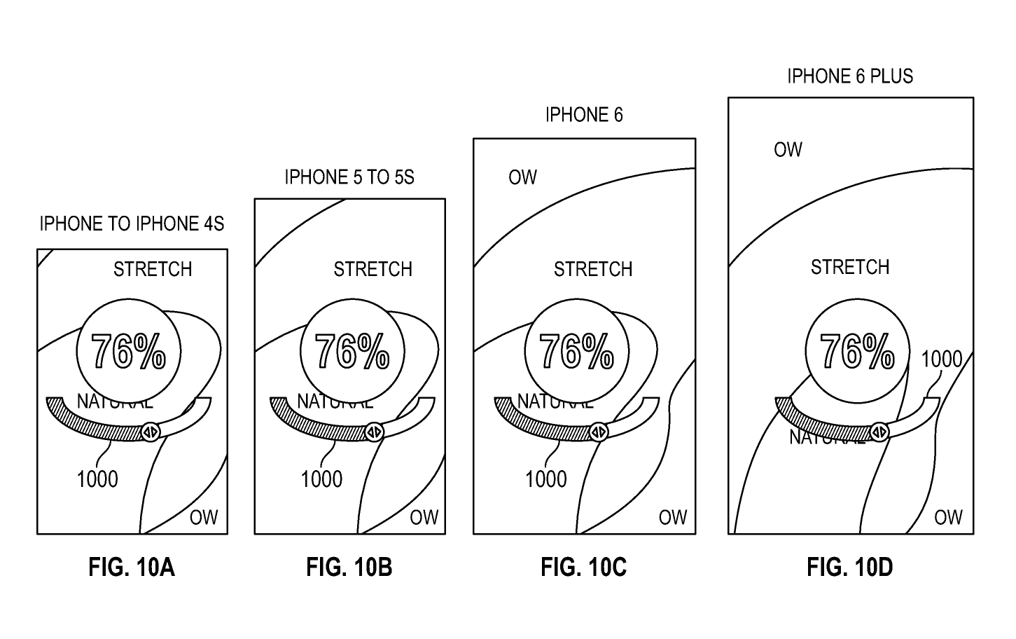

FIG. 7 shows a graph which indicates the threshold 700 below which the second slower speed is used to modify the value at 701 and the above which 702 the first faster speed is used to modify the value at 702.

In FIGS. 8a to 8d, input maps are shown for a various iPhone models.

The input maps comprise three areas on the touchscreen of iPhones when the iPhones are naturally held by right-handed users. The first area is labelled “Natural”. Within this area, the user can comfortably extend their touch to provide input to the device. The second area is labelled “Stretch”. The user can extend their touch to provide input into the second area but it is less comfortable. And the third area is labelled “Ow”. This area is uncomfortably used by users or the user must change their natural grip of the device.

FIGS. 9a to 9d illustrate various embodiments of the invention on the various iPhone models utilising rectilinear input ranges 900, 901, 902, and 903.

It can be seen that some of the embodiments on some of the iPhone models could cause the user to move their touch into the “Stretch” or “Ow” areas of the touchscreen.

FIGS. 10a to 10d illustrate various embodiments of the invention on the various iPhone models utilising a U-shaped curved input range 1000.

The inventors have discovered that the curved input range prevents the user from needed to move into the “Ow” areas and decrease the likelihood of user movement into the “Stretch” areas.

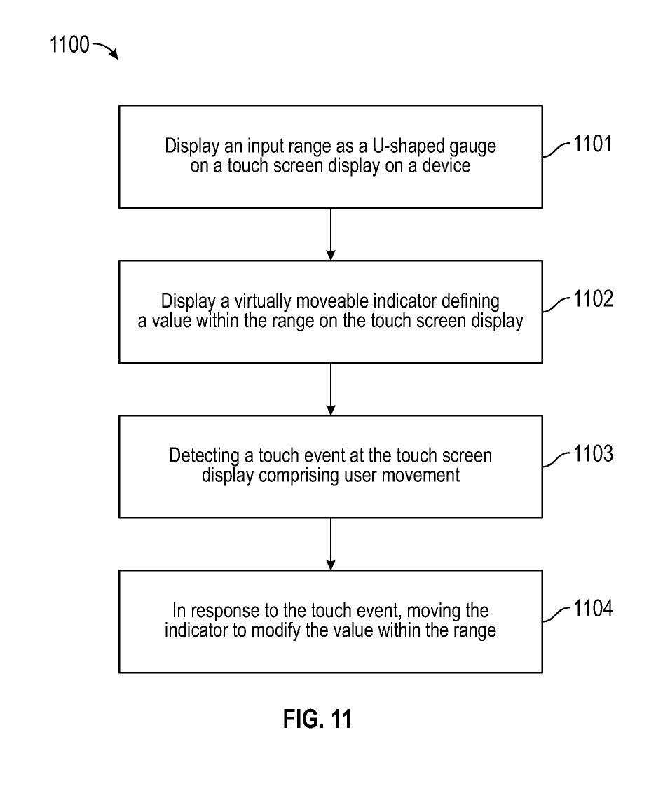

Referring to FIG. 11, a method 1100 for providing a user input mechanism on the device in accordance with an embodiment of the invention will be described.

In step 1101, at a device with a touch screen display, an input range is displayed as a gauge curved in a U-shape.

In step 1102, a virtually moveable indicator is displayed defining a value within the range.

In step 1103, a touch event is detected at the touch screen display comprising user movement.

In step 1104, in response to the touch event, moving the indicator to modify the value within the range.

A potential advantage of some embodiments of the present invention is that, by detecting input from the user at different speed levels, higher accuracy can be provided for lower speeds while permitting coarser calibration at higher speeds. A further potential advantage of some embodiments of the present invention is that by providing an input range in a U-shape for touch-screen devices, an improved and more comfortable user interface is provided.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method for receiving user input, comprising:
at a device with a touch screen display:
displaying an input range;
displaying a virtually moveable indicator defining a value within the range;
detecting a touch event at the touch screen display comprising user movement; and
in response to the touch event:
moving the indicator to modify the value within the range at a first constant speed when the speed of the user movement is above a threshold; and
moving the indicator to modify the value within the range at a second constant speed when the speed of the user movement is below the threshold;
wherein the second constant speed is lower than the first constant speed.

2. A method as claimed in claim 1, wherein the input range is displayed as a gauge.

3. A method as claimed in claim 1, wherein the indicator defines a motivation value and the user moves the indicator to define their motivation value.

4. A method as claimed in claim 1, wherein the displayed input range comprises a visual indicator for the entire range and a visual indicator for the range up to the currently defined value.

5. A method as claimed in claim 4, wherein the visual indicator for the range up to the currently defined value changes in colour, hue or brightness as the value changes in response to movement of the indicator.

6. A method as claimed in claim 4, wherein the virtually moveable indicator is represented by the divide between the two visual indicators.

7. A method as claimed in claim 1, wherein the input range is displayed as a curved gauge.

8. A method as claimed in claim 7, wherein the gauge is curved in a U-shape.

9. A method as claimed in claim 1, wherein previously displayed values are represented on the input range.

10. A method as claimed in claim 1, wherein the user movement is within the input range.

11. A method as claimed in claim 1, wherein the touch event comprises selection of the indicator.

12. A method as claimed in claim 1, further including the display of a numeric value corresponding to the value within the range.

13. A computer readable storage medium having stored therein instructions, which when executed by a processor of a device with a touch screen display cause the device to:
perform the method of claim 1.

14. A device, including:
a touch screen display;
one or more processors; and
a computer readable storage medium according to claim 13.

15. A computer-implemented method for receiving user input, comprising:
at a device with a display and input:
displaying an input range;
displaying a virtually moveable indicator defining a value within the range; and
detecting an input event comprising user movement;
in response to the input event:
moving the indicator to modify the value within the range at a first constant speed when the speed of the user movement is above a threshold; and
moving the indicator to modify the value within the range at a second constant speed when the speed of the user movement is below the threshold;
wherein the second constant speed is lower than the first constant speed.

16. A method as claimed in claim 15, wherein the device is a watch.

17. A method as claimed in claim 16, wherein the input is a crown and wherein the user movement comprises rotation of the crown.

18. A computer-implemented method for receiving user input, comprising:
at a device with a touch screen display:
displaying an input range;
displaying a virtually moveable indicator defining a value within the range;
detecting a touch event at the touch screen display comprising user movement; and
in response to the touch event, moving the indicator to modify the value within the range;
wherein the input range is displayed within a gauge curved in a U-shape.

19. A computer readable storage medium having stored therein instructions, which when executed by a processor of a device with a display and input cause the device to:
perform the method of claim 15.

20. A device, including:
A display;
An input;
One or more processors; and
A computer readable storage medium according to claim 19.

21. (canceled)

22. A computer readable storage medium having stored therein instructions, which when executed by a processor of a device with a display and input cause the device to:
perform the method of claim 18.

23. A device, including:
A display;
An input;
One or more processors; and
A computer readable storage medium according to claim 21.
